(19) United States
(12) Patent Application Publication
(10) Pub. No.: US 2019/0318432 A1
(43) Pub. Date: Oct. 17, 2019

(54) Management Method for Combining Electronic Payment and Authorization of Use of a Consumption Object

(71) Applicant: I-Ting Shen, Tainan (TW)

(72) Inventor: I-Ting Shen, Tainan (TW)

(21) Appl. No.: 15/984,507

(22) Filed: May 21, 2018

(30) Foreign Application Priority Data
Apr. 17, 2018 (TW) 107113037

(51) Int. Cl. G06Q 50/12; G06Q 10/02; G06Q 20/40; G07C 9/00

(52) U.S. Cl. CPC G06Q 50/12; G06Q 10/02; G07C 9/00571; G07C 9/00904; G06Q 20/40145

(57) ABSTRACT

A management method includes selecting a consumption object among a plurality of consumption objects through a network by a consumer. The consumer is then guided to input an identification information including at least one biological feature of the consumer. The consumer is guided to execute an electronic payment to pay the charge when the identification information is complete. An order packet including the identification information and the consumption object is sent to a management end after the electronic payment. An authorization information is generated based on the identification information after the management end confirms the order packet is correct. The consumer reaching the consumption object inputs a real-time unlocking information. A solid electronic lock mounted to the consumption object is unlocked when the real-time unlocking information matches with the authorization information. The solid electronic lock remains locked when the real-time unlocking information does not match with the authorization information.

### BACKGROUND OF THE INVENTION

The present invention relates to a management method for combining electronic payment and authorization of use of a consumption object and, more particularly, to a management method involving combination of a remote payment technique and management of a consumption object (such as a room of a hotel or a homestay) through an electronic lock to achieve unattended management of the consumption object and authorization of the period of time to use the consumption object.

Nowadays, a consumer can book a room of a hotel or a homestay via a network and can pay the charge through online credit card payment or in person, and the consumer can get an electronic key (such as an access card for a door of the room) for unlocking a solid electronic lock on the door to thereby enter the room.

However, the electronic key can be easily copied by a guest of the room through use of a specific machine, leading to a loop hole in the management of the rooms of the hotel or the homestay.

Furthermore, the consumer still has to obtain the electronic key from the clerk at the front desk of the hotel or the homestay after the online booking, which is inconvenient.

### BRIEF SUMMARY OF THE INVENTION

In an aspect of the present invention, a management method for combining electronic payment and authorization of use of a consumption object includes:

selecting the consumption object among a plurality of consumption objects constituted by a plurality of rooms through a network by a consumer;

guiding the consumer to input an identification information after selection of the consumption object, wherein the identification information includes at least one biological feature of the consumer, wherein the at least one biological feature includes a face, a fingerprint, an iris, a vein, or a vocal pattern of the consumer;

guiding the consumer to execute an electronic payment to pay a charge resulting from ordering the consumption object when the identification information is complete, completing an order of the consumption object;

sending an order packet to a management end after the electronic payment is completed, wherein the order packet includes the identification information and the consumption object;

generating an authorization information based on the identification information after the management end confirms the order packet is correct;

inputting a real-time unlocking information by the consumer that reaches the consumption object; and

comparing the real-time unlocking information with the authorization information, wherein a solid electronic lock mounted to the consumption object is unlocked when the real-time unlocking information matches with the authorization information, and wherein the solid electronic lock remains locked when the real-time unlocking information does not match with the authorization information.

In an example, the management method further includes storing the authorization information in the solid electronic lock. Inputting the real-time unlocking information includes using an input device of the solid electronic lock to input the real-time unlocking information.

In an example, the management method further includes storing the authorization information in the solid electronic lock and a smart mobile device of the consumer. Inputting the real-time unlocking information includes using the smart mobile device at the consumer to input the real-time unlocking information. When the real-time unlocking information matches with the authorization information stored in the smart mobile device, the real-time unlocking information is transmitted to the solid electronic lock, and the solid electronic lock is unlocked after identifying that the real-time unlocking information matches with the authorized information stored in the solid electronic lock. When the real-time unlocking information does not match with the authorization information stored in the smart mobile device, the real-time unlocking information is not transmitted to the solid electronic lock, and the solid electronic lock remains locked.

In an example, the management method further includes resending the order packet to the management end when sending of the order packet has failed; and cancelling the order when resending of the order packet has failed.

In an example, the management method further includes cancelling the order and informing the consumer when the management end confirms that a content of the order is incorrect.

In an example, the management method further includes cancelling the order when the electronic payment of the consumer has failed.

In an example, the authorization information includes a start date/time and an end date/time of authorized use of the solid electronic lock. When the authorization information matches with the real-time unlocking information and when a time of comparing the real-time unlocking information with the authorization information falls between a period between the start date/time and the end date/time, the solid electronic lock is unlocked. When the authorization information matches with the real-time unlocking information and when the time of comparing the real-time unlocking information with the authorization information falls outside of the period between the start date/time and the end date/time, the authorized use of the solid electronic lock is ended, and the solid electronic lock remains locked.

In another aspect of the present invention, a management method for combining electronic payment and authorization of use of a consumption object includes:

selecting the consumption object among a plurality of consumption objects through a network by a consumer;

guiding the consumer to input an identification information after selection of the consumption object;

guiding the consumer to execute an electronic payment to pay a charge resulting from ordering the consumption object when the identification information is complete, completing an order of the consumption object;

sending an order packet to a management end after the electronic payment is completed, wherein the order packet includes the identification information and the consumption object;

generating an authorization information based on the identification information after the management end confirms the order packet is correct;

inputting a real-time unlocking information by the consumer that reaches the consumption object; and

comparing the real-time unlocking information with the authorization information, wherein a solid electronic lock mounted to the consumption object is unlocked when the real-time unlocking information matches with the authorization information, and wherein the solid electronic lock remains locked when the real-time unlocking information does not match with the authorization information.

In an example, the management method further includes resending the order packet to the management end when sending of the order packet has failed; and cancelling the order when resending of the order packet has failed.

In an example, the management method further includes cancelling the order and informing the consumer when the management end confirms that a content of the order is incorrect.

In an example, the management method further includes cancelling the order when the electronic payment of the consumer has failed.

In an example, the authorization information includes a start date/time and an end date/time of authorized use of the solid electronic lock. When the authorization information matches with the real-time unlocking information and when a time of comparing the real-time unlocking information with the authorization information falls between a period between the start date/time and the end date/time, the solid electronic lock is unlocked. When the authorization information matches with the real-time unlocking information and when the time of comparing the real-time unlocking information with the authorization information falls outside of the period between the start date/time and the end date/time. The authorized use of the solid electronic lock is ended, and the solid electronic lock remains locked.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings Where:

FIG. 1 is a schematic diagram illustrating a management method for combining electronic payment and authorization of use of a consumption object of an example according to the present invention.

FIG. 2 is a flowchart illustrating an example of the management method according to the present invention,

All figures are drawn for ease of explanation of the basic teachings only; the extensions of the figures with respect to number, position, relationship, and dimensions of the parts to form the illustrative embodiments will be explained or will be within the skill of the art after the following teachings have been read and understood. Further, the exact dimensions and dimensional proportions to conform to specific force, weight, strength, and similar requirements will likewise be within the skill of the art after the following teachings have been read and understood.

### DETAILED DESCRIPTION OF THE INVENTION

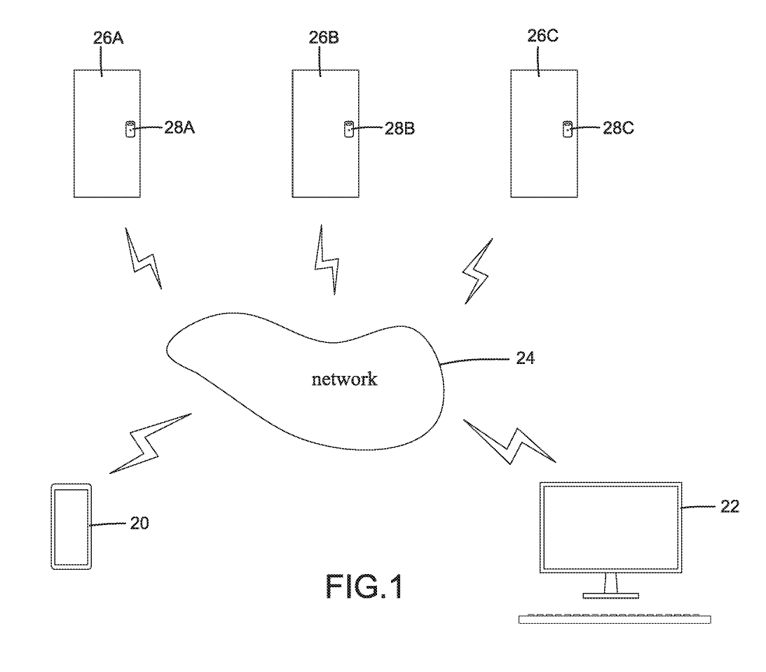

FIG. 1 shows a schematic diagram illustrating a management method for combining electronic payment and authorization of use of a consumption object 26A, 26B, 26C of an example according to the present invention. In this embodiment, the management method is used to combine electronic payment and authorization of use of a room (the consumption object) selected among a plurality of rooms (first, second, and third consumption objects 26A, 26B, and 26C in this embodiment) of a hotel or a homestay through a network 24 by a consumer. Each of the plurality of rooms has a door that can be closed. Each door has a solid electronic lock 28A, 28B, 28C mounted thereon for controlling access to the door. Specifically, when the solid electronic lock 28A, 28B, 28C is locked, the corresponding door cannot be opened to avoid use of a corresponding one of the first, second, and third consumption objects 26A, 26B, and 26C. If the consumer is authorized to unlock one of the solid electronic locks 28A, 28B, and 28C, the consumer can open the corresponding door and can use the corresponding one of the first, second, and third consumption objects 26A, 26B, and 26C. Furthermore, each solid electronic lock 28A, 28B, 28C is connected through the network 24 to a management end 22. The network 24 can include the Internet or Global System for Mobile Communications or both.

The consumer can use a smart mobile device 20 to connect the network 24, thereby obtaining information (such as the size, style, price, holding capacity, and bookable date) of each of the first, second, and third consumption objects 26A, 26B, and 26C. The corresponding information of each of the first, second, and third consumption objects 26A, 2613, and 26C can be obtained through a website and/or an application installed in the smart mobile device 20 after browsing by using the smart mobile device 20. Alternatively, the corresponding information of each of the first, second, and third consumption objects 26A, 26B, and 26C can be obtained by using a tablet computer, a desktop computer, and a notebook computer after browsing the network 24.

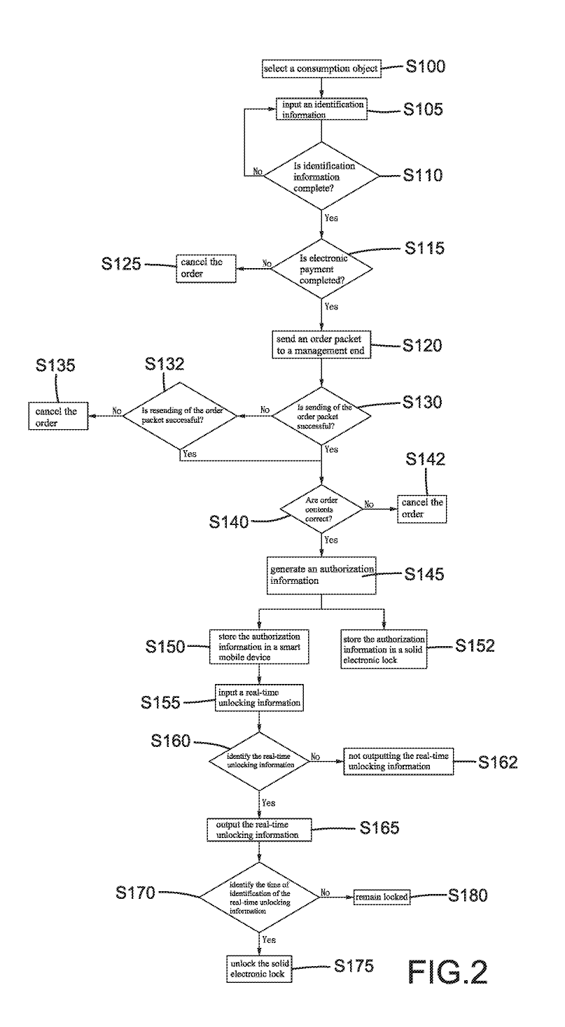

FIG. 2 is a flowchart illustrating an example of the management method according to the present invention. The consumer uses the smart mobile device 20 to select the consumption object among the first, second, and third consumption objects 26A, 26B, and 26C (step S100). After selection of the consumption object, the consumer is guided to select the start date/time and the end date/time (the period of time of authorized use of the selected consumption object). In an example, the consumer uses an application stored in the smart mobile device 20 to obtain the information of the first, second, and third consumption objects 26A. 26B, and 26C and selects the desired one. For the sake of explanation, it is assumed that the first consumption object 26A is selected.

After the consumer selects the first consumption object 26A, the consumer is guided by the system used by the hotel or the homestay to input an identification information (step S105), forming an order. The order includes the first consumption object 26A selected by the consumer and the identification information. The identification information can be, but not limited to, the name, telephone number, contact address, and at least one biological feature of the consumer. The at least one biological feature includes a face, a fingerprint, an iris, a vein, or a vocal pattern of the consumer. In an example, a fingerprint pick-up device on the smart mobile device 20 can be used to pick up a fingerprint of the consumer to serve as the biological feature. In another example, a microphone on the smart mobile device 20 can be used to pick up the voice of the consumer to serve as the biological feature. The name, telephone number, and contact address can be inputted through a touch panel of the smart mobile device 20.

After the consumer has inputted the identification information, the system checks whether the identification information is complete (step S110). If the identification information is incomplete, the system re-guides the consumer to input the identification information until the identification information is complete and clear.

After the consumer has inputted complete identification information, the consumer is guided to execute electronic payment to pay the charge resulting from ordering the first consumption object 26 (step S115). The electronic payment can be done by a remote payment technique or a proximity payment technique (mobile payment). An example of the remote payment includes paying the charge of the first consumption object 26A by online credit card payment or third-party payment Examples of the proximity payment includes near-field communication (NFC) and Quick Response Code (QR Code).

If the electronic payment is conducted by online credit card payment or mobile payment, the consumer can use a credit card linked to the smart mobile device 20 to pay the charge resulting from ordering the first consumption object 26A. If the electronic payment is conducted by a third-party payment, the charge can be paid through the third party resulting from ordering the first consumption object 26A.

If the electronic payment is conducted by proximity payment, after the consumer reaches the first consumption object 26A, the smart mobile device 20 picks up the QR Code on the first consumption object 26A to pay the charge. Alternatively, the consumer uses the smart mobile device 20 to proceed with a near field communication with the solid electronic lock 28A on the first consumption object 26A, thereby paying the charge.

If the electronic payment of the consumer fails, the system cancels the order of the consumer (step S125). If the electronic payment succeeds, the identification information, the first consumption object 26A, and the electronic payment are encoded as an order packet, and the order packet is sent to the management end 22 (step S120). In an example, an encryption technique can be used on the order packet, and the management end 22 can only use a decryption key to read the contents of the order packet, preventing leakage of the information contained in the order packet. Furthermore, the electronic payment information includes the amount of money and the payment method (credit card, third-party payment, or proximity payment).

In step S130, whether sending of the order packet is successful is identified. If the order packet is successfully sent to the management end 22, the order contents will be checked (step S140). On the other hand, if the order packet is not successfully sent to the management end 22, the order packet is resent to the management end 22, and whether resending of the order packet is successful is identified (step S132). If resending of the order packet is unsuccessful, and the order is cancelled (step S135).

After the management end 22 has successfully received the order packet and has decrypted the order packet to obtain the order information regarding the first consumption subject 26A, the identification information, and the electronic payment, the management end 22 checks whether the order information is correct (step S140). The order is cancelled when the order contents are erroneous (step S145). A refunding procedure is carried out, and the consumer is informed of cancellation of the order. On the other hand, if the order contents are correct, an authorization information is generated based on the identification information (step S145). In an example, the authorization information includes a start date/time and an end date/time of authorized use of the solid electronic lock 28A. Note that the order contents can be checked manually or by computerized operation.

After the management end 22 has generated the authorization information, the authorization information is sent to and stored in the smart mobile device 20 (step S150). At the same time, the authorization information is sent to and stored in the solid electronic lock 28A of the first consumption object 26A (step S152). The authorization information can be sent to a smart mobile device 20 that can be designated and used by the consumer, and transmission of the authorization information can be achieved after the connection between the management end 22 and the smart mobile device 20 has been established. Thus, authorization of use of the first consumption object 26A is completed. Next, the consumer can unlock the solid electronic lock 28A of the first consumption object 26A through use of the authorization information.

When the consumer reaches and wishes to enter the first consumption object 26A, the consumer uses the smart mobile device 20 to input a real-time unlocking information (step S155). The real-time unlocking information is a biological feature of the same type as the identification information, such as the fingerprint or the facial feature of the consumer. In an example, an application (such as an application for booking the room of the hotel or homestay) can be downloaded into the smart mobile device 20 to guide the consumer to input the real-time unlocking information.

The real-time unlocking information is compared with the authorization information (step S160). When the real-time unlocking information matches with the authorization information stored in the smart mobile device 20, the real-time unlocking information is transmitted to the solid electronic lock 28A (step S165). The solid electronic key 28A identifies whether a time of comparing the real-time unlocking information with the authorization information falls between a period between the start date/time and the end date/time (step S170). When the authorization information stored in the solid electronic lock 28A matches with the real-time unlocking information and when the time of comparing the real-time unlocking information with the authorization information falls between a period between the start date/time and the end date/time, the solid electronic lock 28A is unlocked (step S175). Thus, the door can be opened to permit use of the first consumption object 26A. On the other hand, when the authorization information matches with the real-time unlocking information stored in the solid electronic lock 28A and when the time of comparing the real-time unlocking information with the authorization information stored in the solid electronic lock 28A falls outside of the period between the start date/time and the end date/time, the authorized use of the solid electronic lock is ended, and the solid electronic lock 28A remains locked (step S180).

On the other hand, when the real-time unlocking information does not match with the authorization information stored in the smart mobile device 20, the real-time unlocking information is not transmitted to the solid electronic lock 28A (step S162), and the solid electronic lock 28A remains locked.

It can be appreciated that the management method according to the present invention applies even when the consumer selects more than one of the first, second, and third consumption objects 26A, 26B, and 26C.

The management method according to the present invention combines electronic payment and authorization of use of the consumption object selected by the consumer. The consumer pays the charge and obtains the authorization through the network 24, which is highly convenient to the consumer. As for the management end of the hotel or the homestay, the management of authorization can be more effective to reduce the management costs.

Now that the basic teachings of the present invention have been explained, many extensions and variations will be obvious to one having ordinary skill in the art. For example, after the consumption object is selected, the system does not have to guide the consumer to select the period between the start date/time and the end date/time of authorized use of the solid electronic lock 28A, 28B, 28C that can be locked and unlocked many times. In a case that the management method according to the present invention is applied in a situation other than booking a room of a hotel or homestay, a one-time authorization may be involved. In other words, without the start date/time and the end date/time of authorized use of the consumption object 26A, 26B, 26C, the solid electronic lock 28A, 28B, 28C can be unlocked only one time. After that, the consumer is not permitted to use the same authorization information to unlock the solid electronic lock 28A. 28B, 28C again. Thus, the management method according to the present invention can be applied in sale of goods stored in a smart locker (such as unmanned aerial vehicle service).

Alternatively, the management method according to the present invention does not have to include the step S150 of storing the authorization information in the smart mobile device 20 of the consumer. Namely, the authorization information is only stored in the solid electronic lock 28A, 28B, 28C (step S152). The solid electronic lock 28A, 28B, 28C mounted to the consumption object 26A, 26B, 26C is unlocked when the real-time unlocking information matches with the authorization information. The solid electronic lock 28A, 28B, 28C remains locked when the real-time unlocking information does not match with the authorization information.

Alternatively, the management method according to the present invention does not have to include the step of storing the authorization information in smart mobile device 20 of the consumer and the solid electronic lock 28A, 28B, 28C (steps S150 and S152). Namely, the authorization information is only stored in the management end. After the consumer uses the smart mobile device 20 to input the real-time unlocking information, the real-time unlocking information is sent to the solid electronic lock 28A, 28B, 28C. The solid electronic lock 28A, 28B, 28C transmits the real-time unlocking information to the management end 22 through the network 24 for identification (such as by a computer). When the management end 22 identities the real-time unlocking information is correct, the management end controls unlocking of the solid electronic lock 28A, 28B, 28C (such as by the computer). When the management end 22 identifies the real-time unlocking information is incorrect, the management end 22 does not unlock the solid electronic lock 28A, 28B, 28C.

Alternatively, instead of using the smart mobile device 20 to input a real-time unlocking information, each solid electronic lock 28A, 28B, 28C can include a biological feature input device, such that the consumer can directly input the biological feature into the solid electronic lock 28A, 28B, 28C.

Furthermore, the management method according to the present invention can applied in a situation other than booking a room of a hotel or homestay, such as renting a vehicle (such as a bicycle, a car, a motorcycle, etc.) or online shopping.

In the case of renting a car, a solid electronic lock 28A, 28B, 28C is mounted on a door of the car. The consumer can obtain related information and location of the car to be rent through browsing and then goes to the location of the car to pay the charge through proximity payment, obtaining an authorized information of the car. Next, the consumer uses the smart mobile device 20 to input the authorized information of the car to thereby unlock the solid electronic lock 284, 28B, 28C, obtaining authorized use of the car.

In the case of online shopping, the purchased merchandise can be delivered to and placed in a locker having a door on which a solid electronic lock 284, 283, 28C is mounted. Likewise, after obtaining an authorized information through proximity payment, the consumer uses the smart mobile device 20 to input the authorized information to thereby unlock the solid electronic lock 28A, 28B, 28C, obtaining the merchandise shopped by the consumer.

Thus since the invention disclosed herein may be embodied in other specific forms without departing from the spirit or general characteristics thereof, some of Which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A management method for combining electronic payment and authorization of use of a consumption object, with the method comprising:
selecting the consumption object among a plurality of consumption objects constituted by a plurality of rooms through a network by a consumer;
guiding the consumer to input an identification information after selection of the consumption object, wherein the identification information includes at least one biological feature of the consumer, wherein the at least one biological feature includes a face, a fingerprint, an iris, a vein, or a vocal pattern of the consumer;
guiding the consumer to execute an electronic payment to pay a charge resulting from ordering the consumption object when the identification information is complete, completing an order of the consumption object;
sending an order packet to a management end after the electronic payment is completed, wherein the order packet includes the identification information and the consumption object;
generating an authorization information based on the identification information after the management end confirms the order packet is correct;
inputting a real-time unlocking information by the consumer that reaches the consumption object; and
comparing the real-time unlocking information with the authorization information, wherein a solid electronic lock mounted to the consumption object is unlocked when the real-time unlocking information matches with the authorization information, and wherein the solid electronic lock remains locked when the real-time unlocking information does not match with the authorization information.

2. The management method for combining electronic payment and authorization of use of the consumption object as claimed in claim 1, further comprising:
storing the authorization information in the solid electronic lock,
wherein inputting the real-time unlocking information includes using an input device of the solid electronic lock to input the real-time unlocking information.

3. The management method for combining electronic payment and authorization of use of the consumption object as claimed in claim 1, further comprising:
storing the authorization information in the solid electronic lock and a smart mobile device of the consumer,
wherein inputting the real-time unlocking information includes using the smart mobile device at the consumer to input the real-time unlocking information,
wherein when the real-time unlocking information matches with the authorization information stored in the smart mobile device, the real-time unlocking information is transmitted to the solid electronic lock, and the solid electronic lock is unlocked after identifying that the real-time unlocking information matches with the authorized information stored in the solid electronic lock, and
wherein when the real-time unlocking information does not match with the authorization information stored in the smart mobile device, the real-time unlocking information is not transmitted to the solid electronic lock, and the solid electronic lock remains locked.

4. The management method for combining electronic payment and authorization of use of the consumption object as claimed in claim 1, further comprising:
resending the order packet to the management end when sending of the order packet has failed; and cancelling the order when resending of the order packet has failed.

5. The management method for combining electronic payment and authorization of use of the consumption object as claimed in claim 1, further comprising cancelling the order and informing the consumer when the management end confirms that a content of the order is incorrect.

6. The management method for combining electronic payment and authorization of use of the consumption object as claimed in claim 1, further comprising cancelling the order when the electronic payment of the consumer has failed.

7. The management method for combining electronic payment and authorization of use of the consumption object as claimed in claim 1, wherein the authorization information includes a start date/time and an end date/time of authorized use of the solid electronic lock,
wherein when the authorization information matches with the real-time unlocking information and when a time of comparing the real-time unlocking information with the authorization information falls between a period between the start date/time and the end date/time, the solid electronic lock is unlocked, and
wherein when the authorization information matches with the real-time unlocking information and when the time of comparing the real-time unlocking information with the authorization information falls outside of the period between the start date/time and the end date/time, the authorized use of the solid electronic lock is ended, and the solid electronic lock remains locked.

8. A management method for combining electronic payment and authorization of use of a consumption object as claimed in claim 1, with the method comprising:
selecting the consumption object among a plurality of consumption objects through a network by a consumer;
guiding the consumer to input an identification information after selection of the consumption object;
guiding the consumer to execute an electronic payment to pay a charge resulting from ordering the consumption object when the identification information is complete, completing an order of the consumption object;
sending an order packet to a management end after the electronic payment is completed, wherein the order packet includes the identification information and the consumption object;
generating an authorization information based on the identification information after the management end confirms the order packet is correct;
inputting a real-time unlocking information by the consumer that reaches the consumption object; and
comparing the real-time unlocking information with the authorization information, wherein a solid electronic lock mounted to the consumption object is unlocked when the real-time unlocking information matches with the authorization information, and wherein the solid electronic lock remains locked when the real-time unlocking information does not match with the authorization information.

9. The management method for combining electronic payment and authorization of use of the consumption object as claimed in claim 8, further comprising:
resending the order packet to the management end when sending of the order packet has failed; and cancelling the order when resending of the order packet has failed.

10. The management method for combining electronic payment and authorization of use of the consumption object as claimed in claim 8, further comprising cancelling the order and informing the consumer when the management end confirms that a content of the order is incorrect.

11. The management method for combining electronic payment and authorization of use of the consumption object as claimed in claim 8, further comprising cancelling the order when the electronic payment of the consumer has failed.

12. The management method for combining electronic payment and authorization of use of the consumption object as claimed in claim 8, wherein the authorization information includes a start date/time and an end date/time of authorized use of the solid electronic lock,
wherein when the authorization information matches with the real-time unlocking information and when a time of comparing the real-time unlocking information with the authorization information falls between a period between the start date/time and the end date/time, the solid electronic lock is unlocked, and
wherein when the authorization information matches with the real-time unlocking information and when the time of comparing the real-time unlocking information with the authorization information falls outside of the period between the start date/time and the end date/time, the authorized use of the solid electronic lock is ended, and the solid electronic lock remains locked.
